(19) United States
(12) Patent Application Publication
(10) Pub. No.: US 2004/0039522 A1
(43) Pub. Date: Feb. 26, 2004

(54) Cycling route recording system for a bicycle

(76) Inventor: Star Jwo, Li Hsien (TW)

Correspondence Address: HARNESS, DICKEY & PIERCE, P.L.C., P.O. BOX 8910, RESTON, VA, 20195, US

(21) Appl. No.: 10/227,310

(22) Filed: Aug. 26, 2002

(51) Int. Cl. G01C 21/30

(52) U.S. Cl. 701/208; 340/432; 701/209

(57) ABSTRACT

A cycling route recording system includes a speed sensor for generating speed information of a bicycle, and a route recording device coupled to the speed sensor and to be connected to a computer for downloading and uploading route maps of bicycle cycling routes. The route recording device includes a storage device for storing the route maps, a display screen for displaying the route maps thereon, an input unit for providing travel direction information of the bicycle, and a processor for generating a cycling track of the bicycle based on the speed information and the travel direction information. The processor controls the display screen to show the cycling track thereon, the cycling track being superimposed on a selected route map when the latter is displayed on the display screen. The processor further controls storage of the cycling track as a new route map in the storage device.

### BACKGROUND OF THE INVENTION

1. Field of the Invention

The invention relates to a bicycle accessory, more particularly to a cycling route recording system for bicycles.

2. Description of the Related Art

Bicycles are apparently the lightest, most convenient and most inexpensive means of transportation, and cycling is also a popular form of recreational activity. Many cyclists enjoy exploring the countryside or suburbs, and they would share cycling experiences and bicycle trail information with friends over the Internet. On the other hand, satellite navigation systems for motor vehicles have been developed heretofore to provide navigational guidance. A typical satellite navigation system provides built-in electronic maps, and is operable to display maps of a geographical region, routes to destinations, location and movement of the vehicle, etc., so as to enable the driver to instantly identify his location in a specific geographical area and to determine whether he is going on the right track.

However, many bicycle trails are secluded and small, and are not included in ordinary maps or electronic maps in a conventional global positioning system. Besides, the electronic maps do not allow cyclists to make any marks thereon to indicate landmarks, such as a red cottage, a large tree, etc. Furthermore, it is not permissible in the prior art for cyclists to share maps of bicycle routes with friends over the Internet. Mere literal description of the routes may not be clear.

### SUMMARY OF THE INVENTION

Therefore, the main object of the present invention is to provide a cycling route recording system which enables cyclists to share bicycle routes with others over the Internet.

According to this invention, a cycling route recording system for a bicycle comprises a speed sensor for generating speed information of the bicycle, and a route recording device coupled to the speed sensor and adapted to be connected to a computer for downloading and uploading route maps of bicycle cycling routes. The route recording device includes a storage device for storing the route maps, a display screen for displaying a selected one of the route maps thereon, an input unit for providing travel direction information of the bicycle, and a processor coupled to the storage device, the display screen, and the input unit.

The processor is operable so as to generate a cycling track of the bicycle based on the speed information of the bicycle obtained from the speed sensor and the travel direction information of the bicycle obtained from the input unit. The processor controls the display screen to show the cycling track thereon, wherein the cycling track is superimposed on the selected one of the route maps when the selected one of the route maps is displayed on the display screen. The processor is further operable so as to control the storage device to store the cycling track as a new route map therein.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view illustrating a bicycle that incorporates a cycling route recording system according to the present invention;

FIG. 2 is a schematic view illustrating the first preferred embodiment of a cycling route recording system according to the present invention;

FIG. 2A is a schematic circuit block diagram of the first preferred embodiment;

FIGS. 3A and 3B are flowcharts to illustrate operation of the first preferred embodiment;

FIG. 4A is a schematic view illustrating how a new route map is created according to the first preferred embodiment;

FIG. 4B is a schematic view illustrating a cycling track generated using a pre-stored route map in the cycling route recording system of the first preferred embodiment;

FIGS. 5A and 5B are flowcharts to illustrate operation of the second preferred embodiment of a cycling route recording system of the present invention, which incorporates a digital compass positioning system;

FIG. 6A is a schematic view illustrating how a new route map is created according to the second preferred embodiment;

FIG. 6B is a schematic view illustrating a cycling track generated using a pre-stored route map in the cycling route recording system of the second preferred embodiment;

FIGS. 7A and 7B are flowcharts to illustrate operation of the third preferred embodiment of a cycling route recording system of the present invention, which incorporates a satellite-based positioning system;

FIG. 8A is a schematic view illustrating how a new route map is created according to the third preferred embodiment;

FIG. 8B is a schematic view illustrating a cycling track generated using a pre-stored route map in the cycling route recording system of the third preferred embodiment; and

FIG. 9 is a schematic view illustrating a display screen and a keypad of a route recording device of the cycling route recording system of the present invention.

### DETAILED DESCRIPTION OF THE PREFERRED EMBODIMENTS

Before the present invention is described in greater detail, it should be noted that like elements are denoted by the same reference numerals throughout the disclosure.

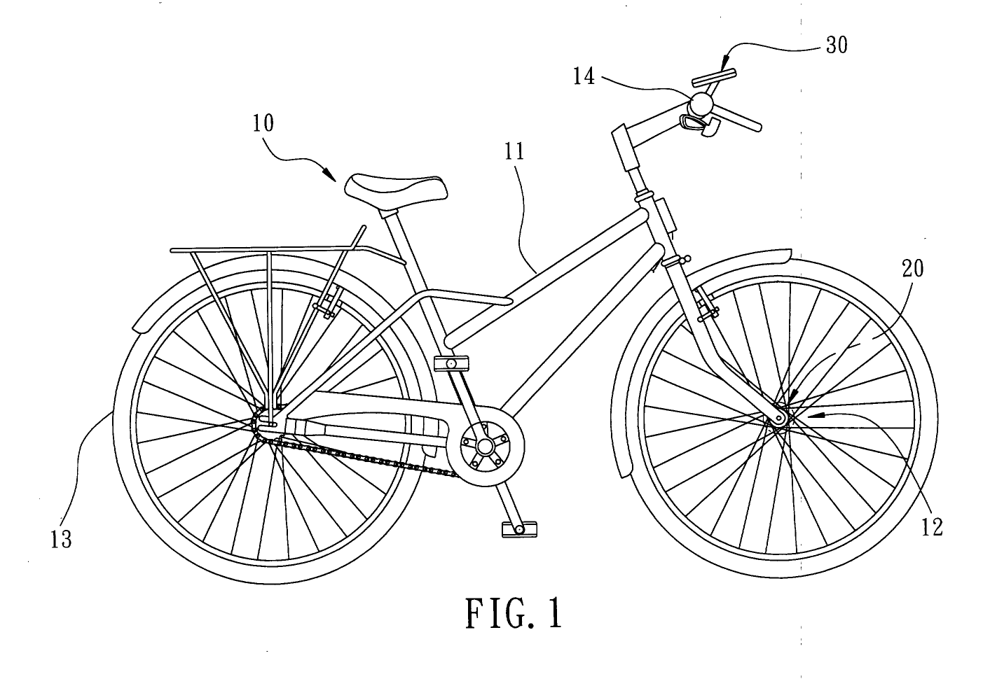

Referring to FIG. 1, the cycling route recording system according to the present invention is shown to be adapted for use with a bicycle 10. The bicycle 10 includes a frame unit 11, front and rear wheel devices 12, 13 mounted on the frame unit, and a handlebar member 14 mounted on the frame unit 11.

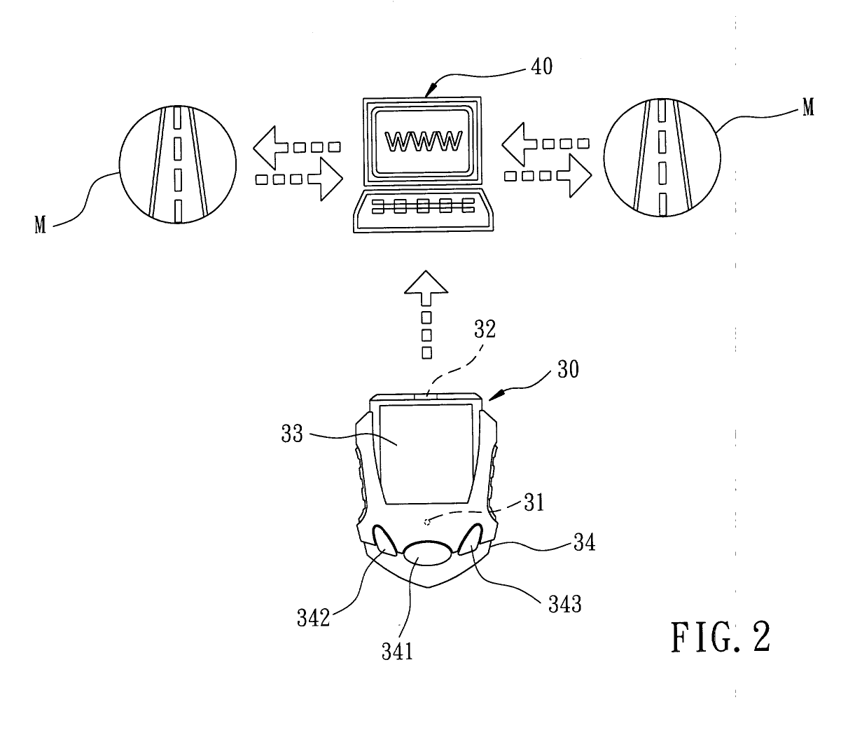

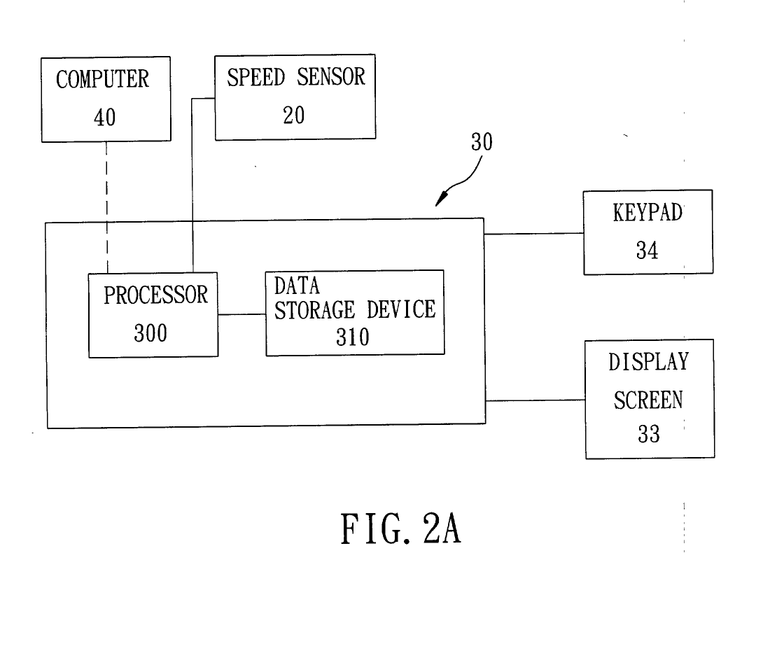

Referring further to FIGS. 2, 2A, 3A, 3B, 4A and 4B, the first preferred embodiment of the cycling route recording system of this invention is shown to include a known speed sensor 20 mounted on the front wheel device 12 for detecting the traveling speed of the bicycle 10, and a route recording device 30 mounted on the handlebar member 14. The route recording device 30 includes a processor 300 coupled to the speed sensor 20 via a first connecting port 31 so as to obtain speed information of the bicycle 10 from the speed sensor 20, and coupled to a computer 40 via a second connecting port 32 for downloading available electronic route maps (M) therefrom or uploading new route maps (M) thereto over the Internet. The route recording device 30 further includes a data storage device 310 connected to the processor 300 for storing downloaded or newly created route maps (M) therein, a display screen 33 connected to the processor 300 and operable so as to display cycling tracks (T) of the bicycle 10, a selected route map (M), and selection menus, and a keypad 34 connected to the processor 300 and operable so as to control operation of the route recording device 30. The processor 300 is operable in a map-creating mode for creating new route maps (M) based on the cycling tracks (T) of the bicycle 10 shown on the display screen 33 and to be stored in the data storage device 310. The processor 300 is further operable in a map-navigating mode so as to retrieve from the data storage device 310 a selected route map (M) that was downloaded over the Internet or loaded thereinto, and to generate the cycling tracks (T) which are superimposed on predetermined cycling tracks (T′) in the selected route map (M) when the latter is shown on the display screen 33. The display screen 33 is preferably provided with a touch control panel to permit input of commands by hand. The keypad 34 is constructed to include a control key 341, and a left key 342 and a right key 343 that serve as direction keys. In this embodiment, aside from serving as an input unit for providing travel direction information of the bicycle 10, the keypad 34 is further operable to choose from the selection menus, to initiate or stop cycling route recording, and to enter icons and description of locations or interesting sites on the route map (M) that is shown on the display screen 33.

In the first preferred embodiment of the cycling route recording system according to the invention, the travel direction information of the bicycle 10 is provided manually with the use of the keypad 34.

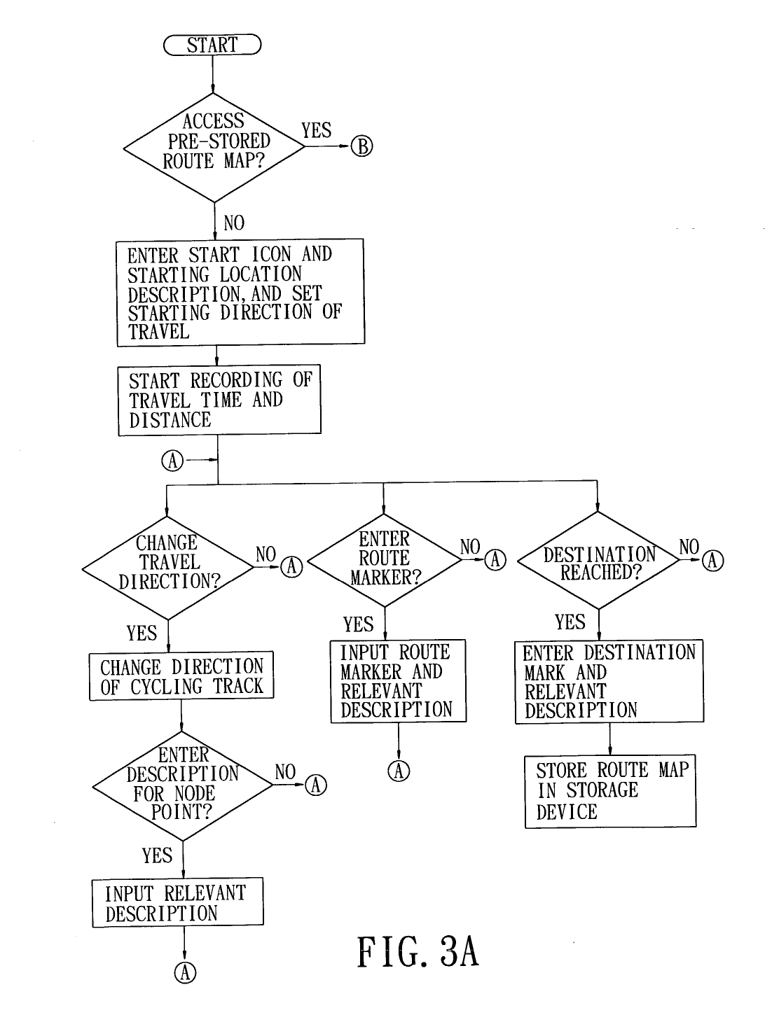

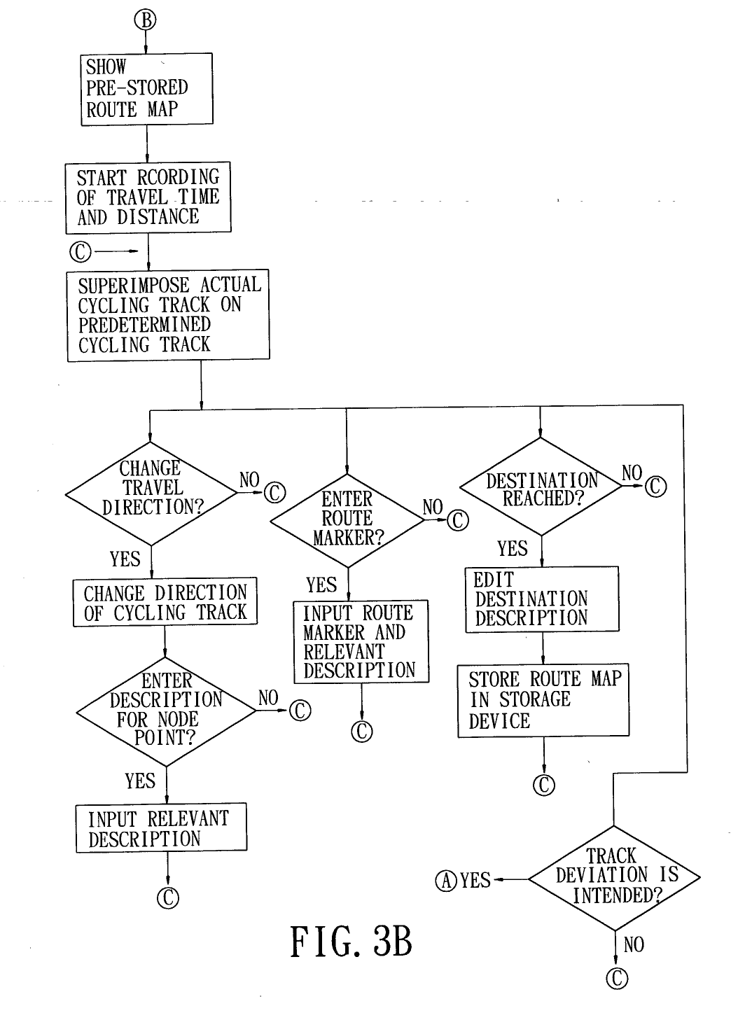

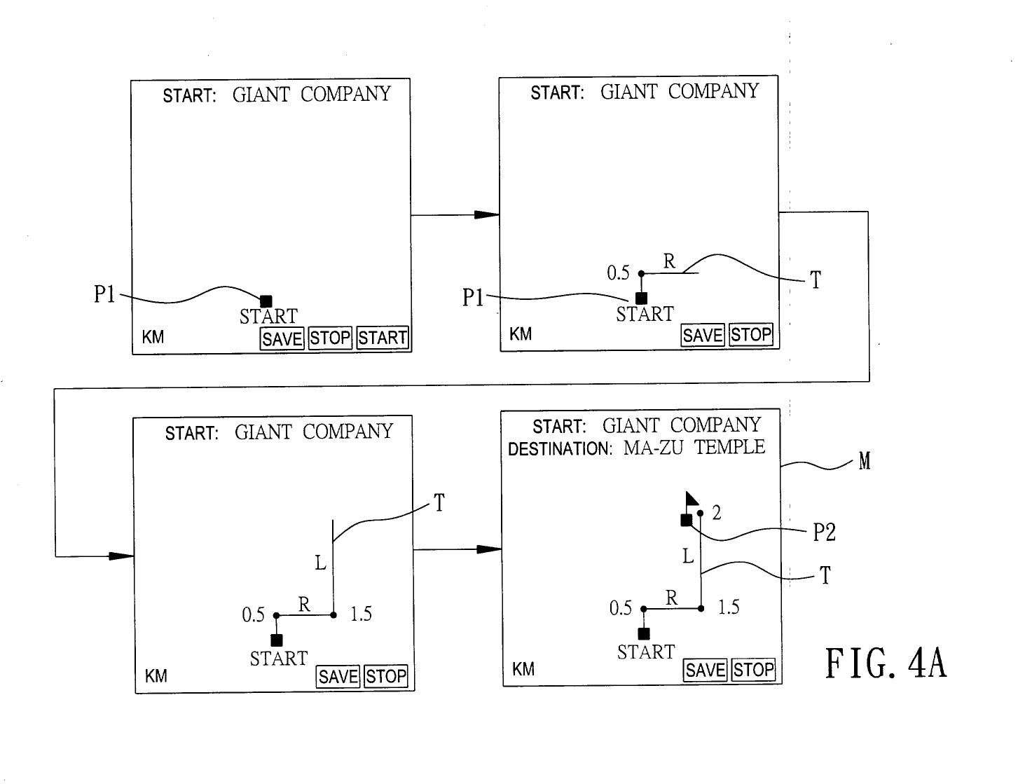

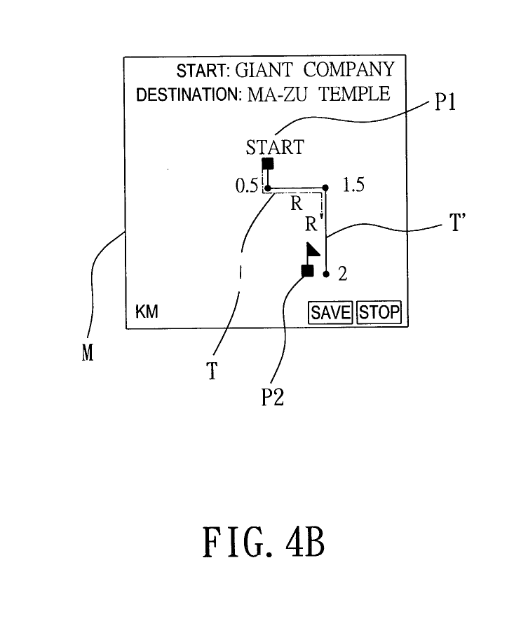

With reference to FIGS. 3A and 4A, in operation, the cyclist initiates a cycling route recording operation of the route recording device 30 via the keypad 34. The display screen 33 displays a selection menu and an inquiry to verify if a pre-stored route map (M) is to be accessed. In the negative, the cyclist enters a start icon (P1) and description of the starting location, and sets a starting direction of travel by operating the control key 341 and the left and right keys 342, 243 of the keypad 34. Upon further operation of the control key 341, the route recording device 30 starts recording the time and the distance traveled by the bicycle 10 according to the speed information of the speed sensor 20, and the processor 300 controls the display screen 33 to display a cycling track (T) of the bicycle 10 thereon. The cycling track (T) is generated by the processor 300 according to the initially set direction of travel and the distance traveled by the bicycle 10. When the cyclist encounters a bend or a fork on the way, he/she can press the left key 342 or the right key 343 to change the direction of the cycling track (T), and a node point is displayed on the cycling track (T) to indicate the change of direction. The cyclist has the option of entering a description for the node point. In the positive, the cyclist can call up a description entry page to input the relevant description. The cyclist can also enter route markers and relevant description to indicate landmarks or points of interest met along the way to a point of destination. When the cyclist reaches his/her destination, he/she can enter a destination mark (P2) and a relevant description. The route map (M) thus created, as shown in FIG. 4A, together with the relevant information, is then saved and stored by the processor 300 in the data storage device 310.

With reference to FIGS. 3B and 4B, if the cyclist opts to access a route map (M) of a specific location stored in the system, the display screen 33 will show the selected route map (M) with a predetermined cycling track (T′) and relevant information. The cyclist then needs to go to the place corresponding to the starting point (P1) on the route map (M) before initiating a route recording operation by operating the control key 341 of the keypad 34. The route recording device 30 will operate in the manner described hereinabove to generate a cycling track (T) of the bicycle 10 on the route map (M) that is superimposed on the predetermined cycling track (T′) on the route map (M) if the cyclist follows the predetermined cycling track (T′), as best shown in FIG. 4B. When the cyclist travels to where the direction of travel is to be changed, and wishes to keep following the path of the predetermined cycling track (T′), the cyclist presses the left key 342 or the right key 343 to change the direction of the cycling track (T) shown on the display screen 33. If the cyclist wishes to enter a relevant description for the node point of change, he/she can call up a description entry screen to input the relevant description. In addition, the cyclist can also set route markers along the predetermined cycling track (T′) and, optionally, relevant description, via the keypad 34. At the destination, i.e., the cycling track (T) has reached the destination icon (P2), the cyclist can edit the destination description, if necessary. The edited route map (M) is then saved and stored by the processor 300 in the data storage device 310.

When the cycling track (T) deviates from the predetermined cycling track (T′), and deviation from the predetermined cycling track (T′) is not intended, the cyclist can always go back to a previous node on the route map (M) to get back on the right track (see node C in FIG. 3B). When the system verifies that the cyclist does not intend to follow the predetermined cycling track (T′), the system will continue with the drawing of the cycling track (T) according to the direction of travel of the bicycle 10 as inputted by the cyclist with the use of the left and right keys 342, 343 of the keypad 34 (see Node A in FIG. 3A). Likewise, the cyclist can enter route markers along the cycling track (T) to indicate landmarks, points of interest and the like, and optional relevant description by operating the keypad 34. Thereafter, when the cyclist reaches a desired destination, he/she can enter a new destination icon (P2) and a new destination description, and the route map with the new cycling track (T) is saved as a new route map (M) that is stored by the processor 300 in the data storage device 310.

In this embodiment, since the cycling track (T) is drawn according to the direction of travel of the bicycle 10 as inputted by the cyclist using the left and right keys 342, 343, segments of the cycling track (T) are drawn using straight lines and are at 90 degrees relative to each other at each turn. It is noted that the system of this embodiment can also be used to generate a cycling route that bends and turns according to the directions defined by the direction keys 342, 343.

If the cyclist wishes to share his/her route maps (M) with others, he/she can connect the route recording device 30 with the computer 40 to upload the map data to relevant web sites over the Internet or to e-mail the map data to friends, as best shown in FIG. 2.

Position determining systems, such as a digital compass positioning system, are now available for determining bearings and positions of vehicles. In the second preferred embodiment of this invention, the route recording device 30 further includes a known digital compass positioning system (DCPS) that serves as an input unit for providing travel direction information of the bicycle 10.

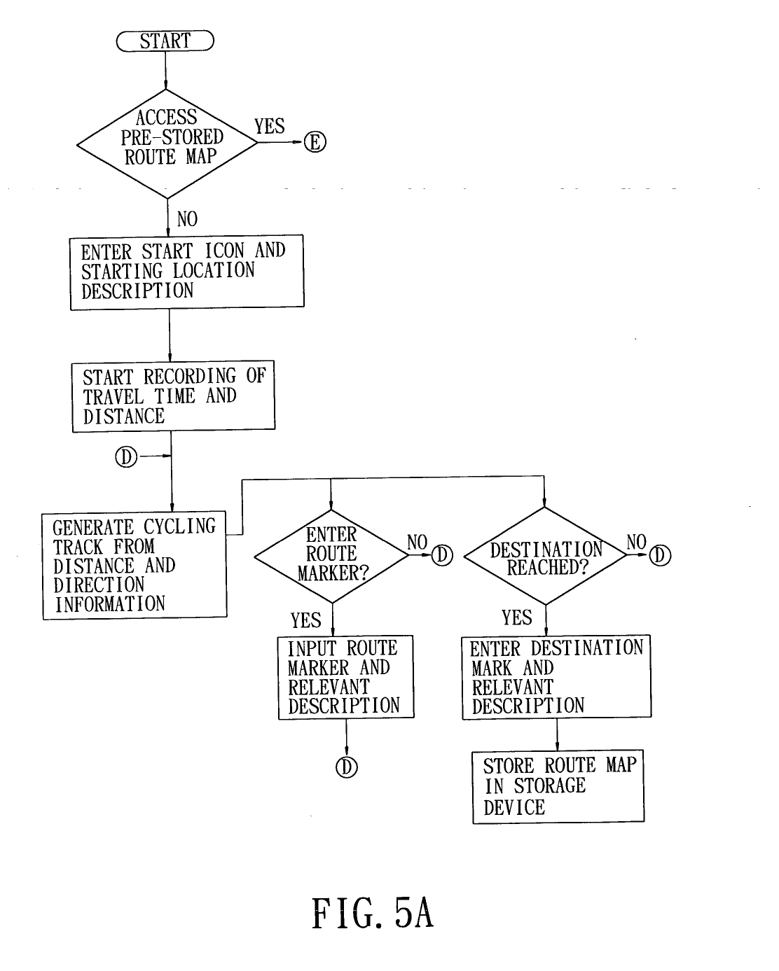

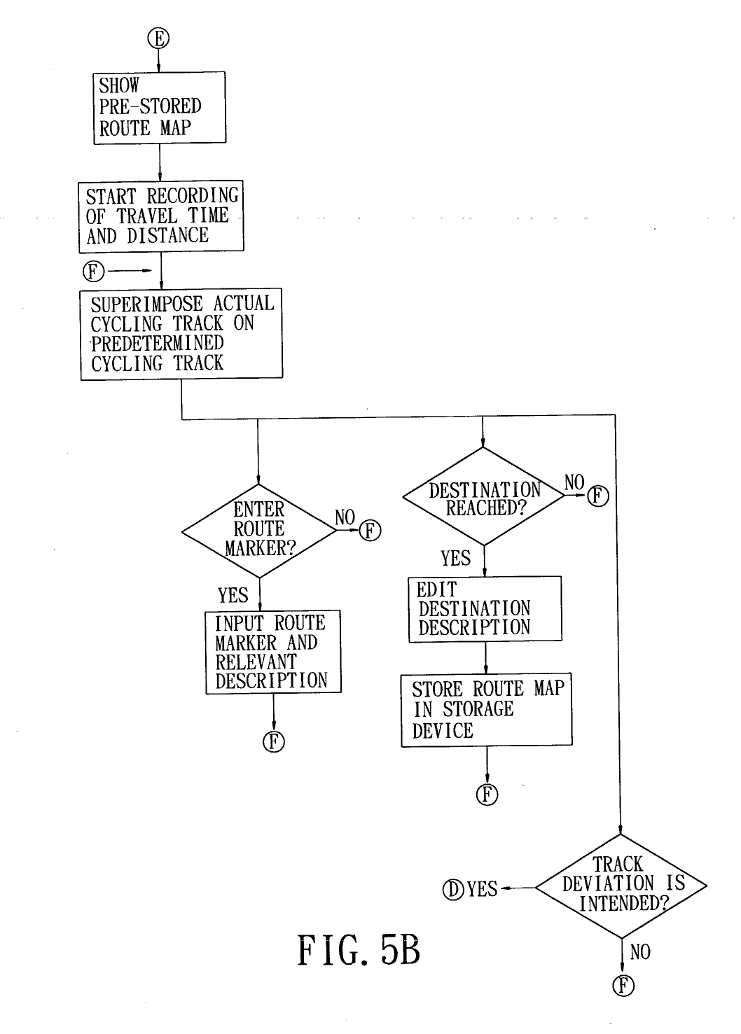

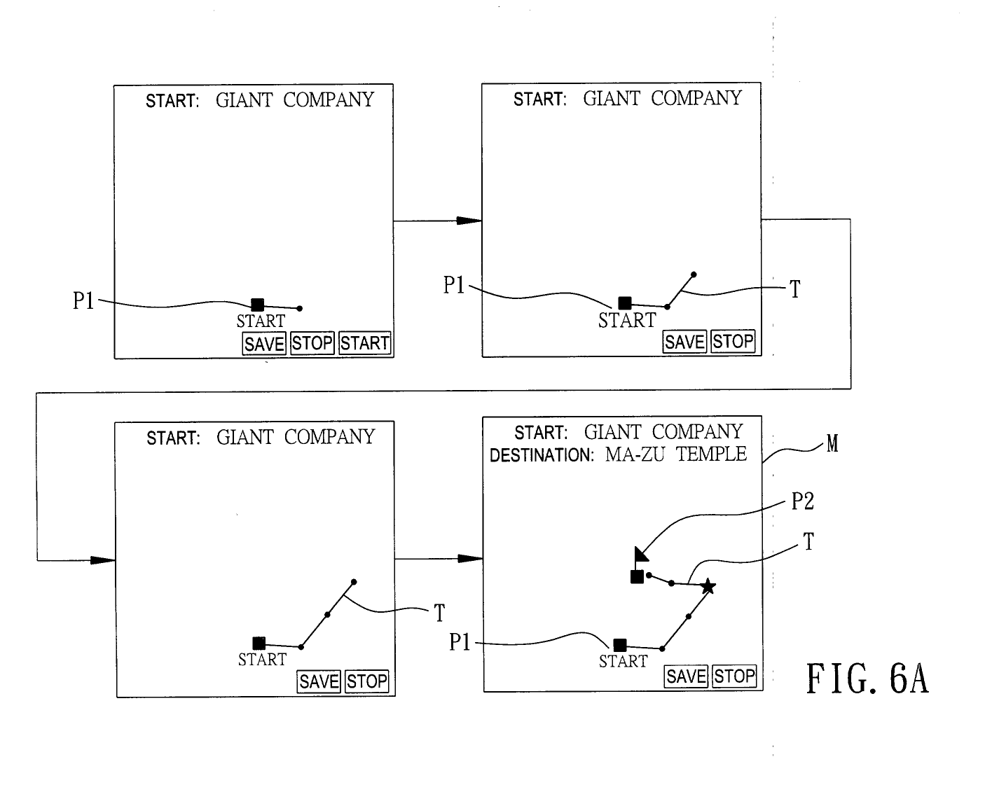

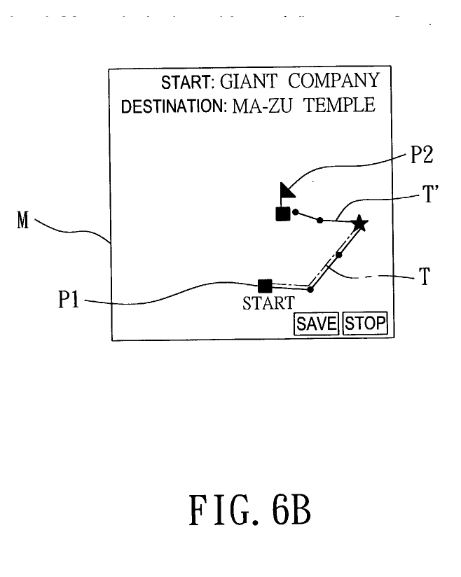

Referring to FIGS. 5A and 6A, in operation, when the cyclist activates the route recording device 30, the display screen 33 will display a selection menu and an inquiry to verify if a pre-stored route map (M) that has been previously downloaded over the Internet is to be accessed. In the negative, the display screen 33 displays a blank screen for the user to create a new route map (M). The keypad 34 is operated to select and enter a start icon (P1) to indicate a starting point and a relevant description for display on the display screen 33. Subsequently, the control key 341 is operated to initiate a route recording operation such that the processor 300 starts recording the time of travel and the distance traveled by the bicycle 10 based on the speed information provided by the speed sensor 20. Moreover, according to the travel direction information provided by the digital compass positioning system, the processor 300 determines and records the direction of travel of the bicycle 10 at predetermined intervals of distance or time. In this embodiment, a distance of 50 m is adopted as a distance unit, and each distance unit is divided into distance segments of 10 m, for instance. A value of the bearing of the bicycle 10 relative to the starting point is recorded at every 10 m traveled by the bicycle 10, and a mean of the five bearing values obtained per every distance unit is recorded. Based on the mean bearing value, the processor 30 determines and displays a node point on the display screen 33. A cycling track (T) of the bicycle 10 is obtained by connecting the starting point and the node points. Thus, the cyclist can note the distance traveled by the bicycle 10, as well as his/her position relative to the starting point, by looking at the display screen 33. When the cyclist encounters a significant landmark or a road sign on the way, he/she can enter a route marker, such as a star, and optional relevant description via the keypad 34. When the cyclist reaches a desired location, he/she can enter a destination icon (P2), such as a flag symbol, and, optionally, a relevant description. The route map (M) thus created, as shown in FIG. 6A, together with the relevant route information, is then saved and stored by the processor 300 in the data storage device 310.

Referring to FIGS. 5B and 6B, if the cyclist opts to access a pre-stored route map (M) of a specific geographic location, the display screen 33 will show the selected route map (M) with a predetermined cycling track (T′) and relevant information. The cyclist then needs to go to the place corresponding to the starting point (P1) on the route map (M) before initiating a route recording operation by operating the control key 341 of the keypad 34. The route recording device 30 will operate in the manner described hereinabove to generate an actual cycling track (T) of the bicycle 10 on the route map (M) that is superimposed on the predetermined cycling track (T′) on the route map (M) if the cyclist follows the predetermined cycling track (T′), as best shown in FIG. 6B. Thus, the cyclist can determine whether or not he/she is traveling on the right cycling route. During the course of travel, the cyclist can also set route markers along the predetermined cycling track (T′) and optional relevant description via the keypad 34. When the cyclist reaches the destination point, i.e., the cycling track (T) has reached the destination icon (P2), the cyclist can edit the destination description, if necessary. The edited route map (M) is then saved and stored by the processor 300 in the data storage device 310.

Like the previous embodiment, when the cycling track (T) deviates from the predetermined cycling track (T′) and deviation from the predetermined cycling track (T′) is not intended, the cyclist can always go back to a previous node on the route map (M) to get back on the right track (see node F in FIG. 5B). When the system verifies that the cyclist does not intend to follow the predetermined cycling track (T′), the system will continue with the drawing of the cycling track (T) according to the bearing and direction of travel of the bicycle 10 in the aforesaid manner (see Node D in FIG. 5A). Likewise, the cyclist can enter route markers along the cycling track (T) to indicate landmarks, points of interest and the like, and optional relevant description by operating the keypad 34. Finally, when the cyclist reaches a desired destination, he/she can enter a new destination icon (P2) and a new destination description, and the route map (M) with the new cycling track (T) is saved as a new route map (M) that is stored by the processor 300 in the data storage device 310.

In this embodiment, since the route recording device 30 is used in conjunction with a digital compass positioning system, the accuracy of the cycling route (T) drawn on the display screen 33 is enhanced.

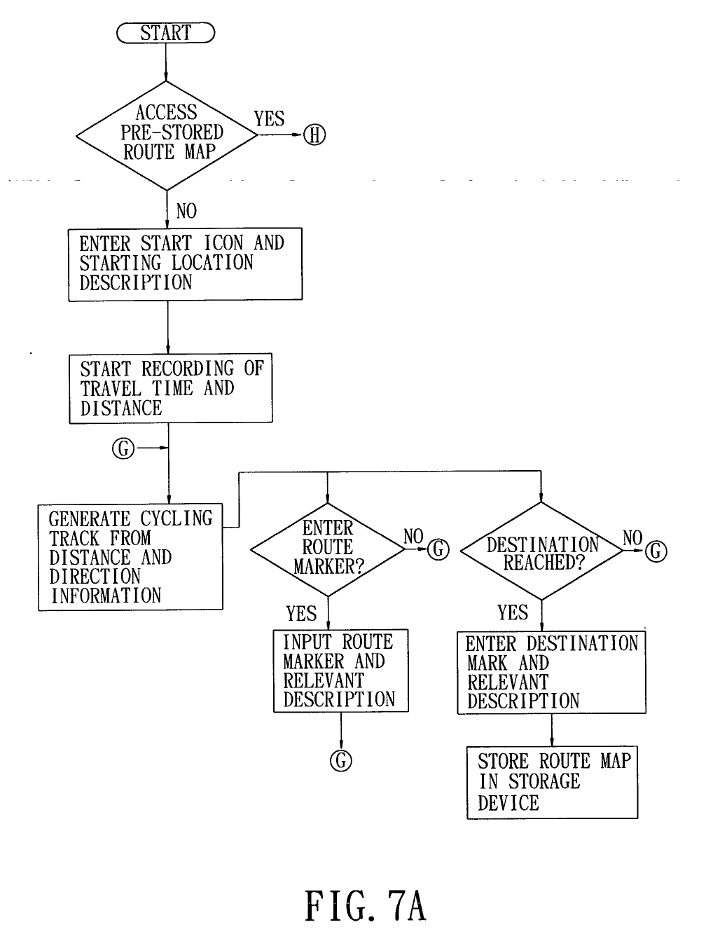

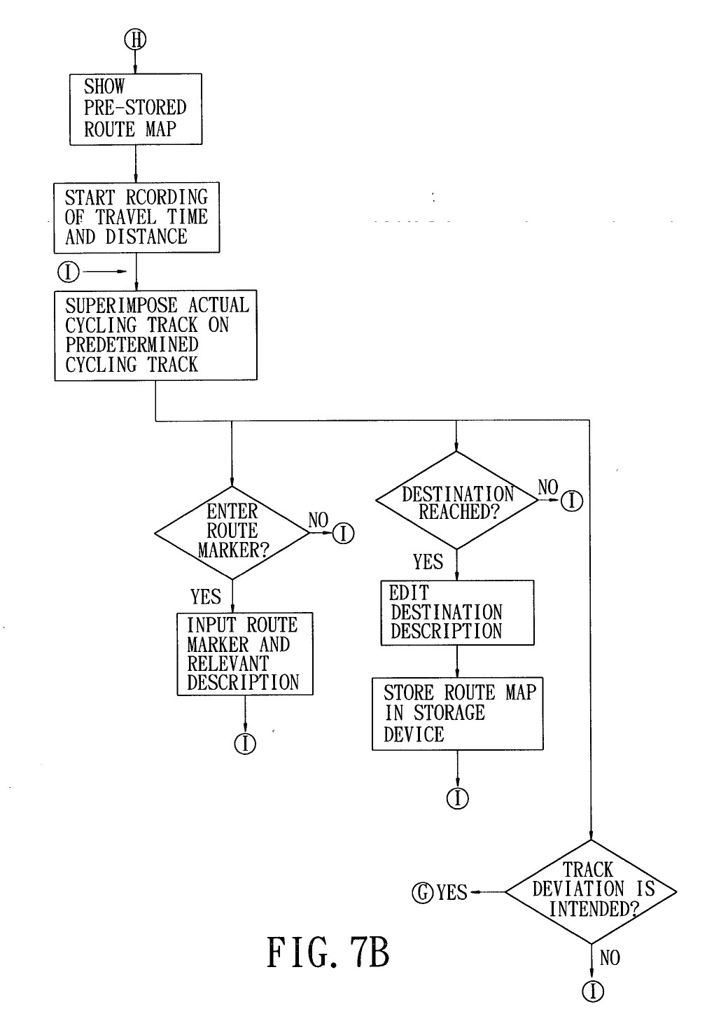

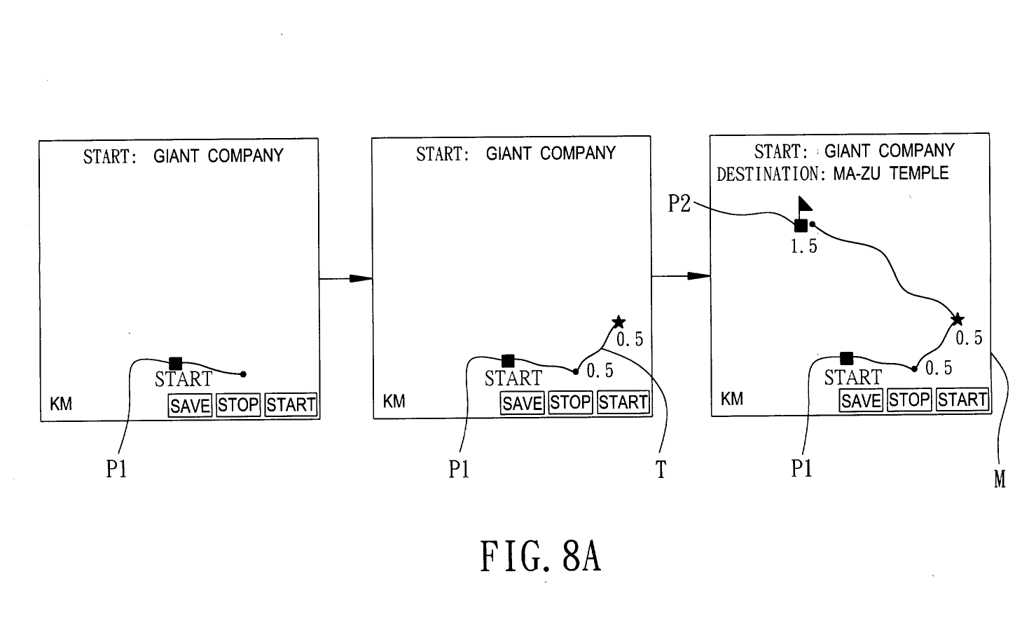

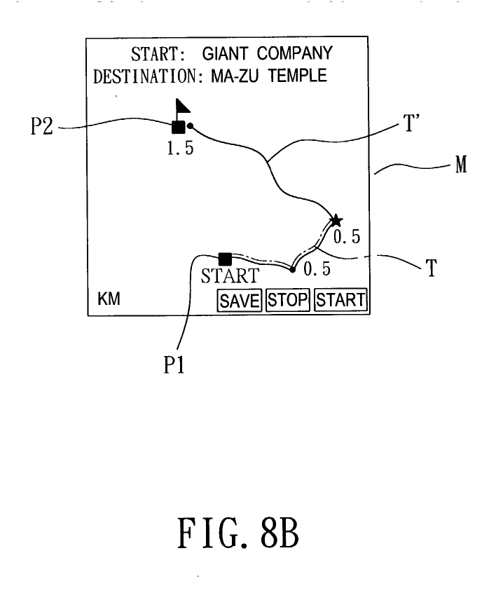

In the present invention, the route recording device 30 can also be implemented in conjunction with a conventional theodolite, gyroscope or satellite-based navigation system that provides information as to the cycling route of movement, position and speed of the bicycle 10, the distance traveled by the bicycle 10, the time at which the bicycle 10 is at a specific location, and other detailed information. FIGS. 7A, 7B, 8A and 8B illustrate the operation of the third preferred embodiment of the present invention, in which the route recording device 30 is implemented in conjunction with a satellite-based navigation system. Referring to FIGS. 7A and 8A, like the previous embodiments hereinbefore described, the cyclist first initiates a route recording operation of the route recording device 30 via the keypad 34, and the display screen 33 will show a selection menu and an inquiry to verify if the cyclist wishes to access a route map (M) stored in the system. In the negative, the cyclist enters a start icon (P1) and a description of the starting location. Thereupon, the system cooperates with the satellite-based navigation system to start recording the time, the distance traveled by the bicycle 10, and the position of the bicycle 10 at predetermined intervals of time or distance, and generates a cycling track (T) of the bicycle 10 that is shown on the display screen 33. The cyclist can also enter route markers, such as a star, and relevant description to indicate landmarks or points of interest along the route. When the cyclist reaches a desired destination, he/she can enter a destination mark (P2) and a relevant description. The route map (M) thus created, as shown in FIG. 8A, together with the relevant information, is then saved and stored by the processor 300 in the data storage device 310.

With reference to FIGS. 7B and 8B, if the cyclist opts to access a route map (M) of a specific location stored in the system, the display screen 33 will show the selected route map (M) with a predetermined cycling track (T′) and relevant information. The cyclist then needs to go to the place corresponding to the starting point (P1) on the route map (M) before initiating a route recording operation of the route recording device 30 by operating the control key 341 of the keypad 34. The route recording device 30 will operate in the manner described hereinabove to generate a cycling track (T) of the bicycle 10 on the route map (M) that is superimposed on the predetermined cycling track (T′) on the route map (M) if the cyclist follows the predetermined cycling track (T′), as best shown in FIG. 8B. The cyclist can likewise set route markers and optional relevant description via the keypad 34. At the destination, the cyclist can edit the destination description, if necessary. The edited route map (M) is then saved and stored by the processor 300 in the data storage device 310.

Like the previous embodiments, when the cycling track (T) deviates from the predetermined cycling track (T′), and deviation from the predetermined cycling track (T′) is not intended, the cyclist can always go back to a previous node on the route map (M) to get back on the right track (see node I in FIG. 7B). Accordingly, when the system verifies that the cyclist does not intend to follow the predetermined cycling track (T′), the system will continue with the drawing of the cycling track (T) based on the direction of travel of the bicycle 10 as determined from information provided by the satellite-based navigation system (see node Gin FIG. 7A). Likewise, the cyclist can enter route markers along the cycling track (T) to indicate landmarks, points of interest and the like, and optional relevant description by operating the keypad 34. Thereafter, when the cyclist reaches a desired destination, he/she can enter a new destination icon (P2) and a new destination description, and the route map with the new cycling track (T) is saved as a new route map (M) that is stored in the data storage device 310 by the processor 300.

In this embodiment, since the cycling track (T) is generated according to information provided by the satellite-based navigation system, the cycling track (T) can be very close to the actual route traveled by the bicycle 10.

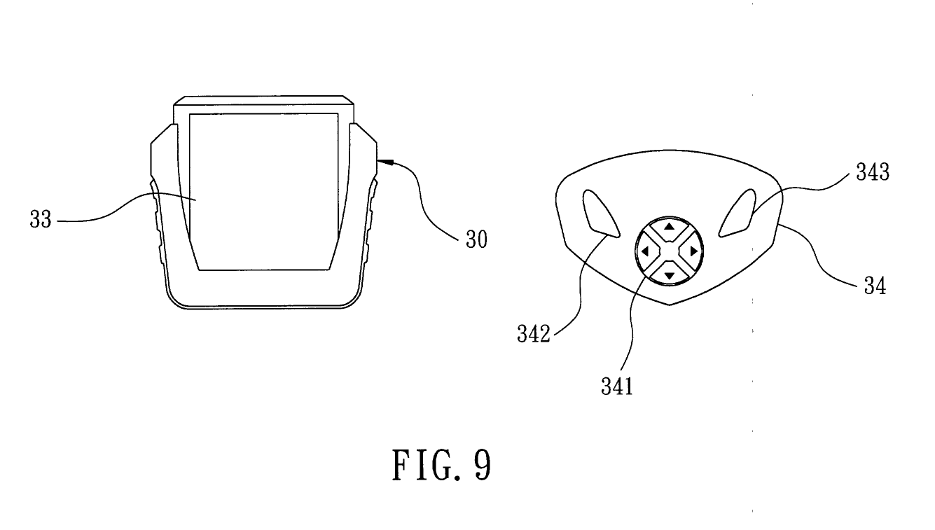

Furthermore, referring to FIG. 9, the keypad 34 and the display screen 33 can be configured as separable components such that the display screen 33 can be secured to a central portion of the handlebar member 14 to facilitate viewing by the cyclist and that the keypad 34 can be secured to a distal end portion of the handlebar member 14 to facilitate manipulation thereof. In addition, the control key 341 can be configured to consist of a four-direction button or an eight-direction button, or a joystick, so as to facilitate manipulation thereof.

With the help of the cycling route recording system of the present invention, the cyclist can explore new bicycle trails and will not become lost, and can create new route maps of his/her own. In addition, by connecting the cycling route recording system of this invention with the computer 40, the cyclist can share route maps with others or download desired route maps via the Internet.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A cycling route recording system for a bicycle, comprising:
a speed sensor for generating speed information of the bicycle; and
a route recording device coupled to said speed sensor and adapted to be connected to a computer for downloading and uploading route maps of bicycle cycling routes, said route recording device including
a storage device for storing the route maps,
a display screen for displaying a selected one of the route maps thereon,
an input unit for providing travel direction information of the bicycle, and
a processor coupled to said storage device, said display screen, and said input unit, said processor being operable so as to generate a cycling track of the bicycle based on the speed information of the bicycle obtained from said speed sensor and the travel direction information of the bicycle obtained from said input unit, said processor controlling said display screen to show the cycling track thereon, wherein the cycling track is superimposed on the selected one of the route maps when the selected one of the route maps is displayed on said display screen, said processor being further operable so as to control said storage device to store the cycling track as a new route map therein.

2. The cycling route recording system as claimed in claim 1, wherein said input unit includes a keypad that is further operable so as to initiate or stop operation of said route recording device and so as to enter icons and description of locations for display on said display screen.

3. The cycling route recording system as claimed in claim 2, wherein said keypad includes a left key, a right key, and a control key, said left and right keys being operable to change direction of the cycling track generated by said processor.

4. The cycling route recording system as claimed in claim 2, wherein said keypad is separable from said display screen.

5. The cycling route recording system as claimed in claim 1, wherein said input unit includes one of a theodolite, a gyroscope, a digital compass positioning system, and a satellite-based positioning system.
